(19) United States
(12) Patent Application Publication
(10) Pub. No.: US 2021/0004735 A1
(43) Pub. Date: Jan. 7, 2021

(54) SYSTEM AND METHOD FOR COLLABORATIVE DECENTRALIZED PLANNING USING DEEP REINFORCEMENT LEARNING AGENTS IN AN ASYNCHRONOUS ENVIRONMENT

(71) Applicant: Siemens Corporation, Iselin, NJ (US)

(72) Inventors: Krzysztof Chalupka, Bellevue, WA (US); Sanjeev Srivastava, Princeton Junction, NJ (US)

(21) Appl. No.: 16/979,430

(22) PCT Filed: Mar. 20, 2019
(86) PCT No.: PCT/US2019/023125

§ 371 Date: Sep. 9, 2020

Related U.S. Application Data
(60) Provisional application No. 62/646,404, filed on Mar. 22, 2018.

(51) Int. Cl. G06Q 10/06; G06K 9/62; G06N 20/00

(52) U.S. Cl. CPC G06Q 10/063; G06N 20/00; G06K 9/6263

(57) ABSTRACT

A method, and corresponding systems and computer-readable mediums, for implementing a hierarchical multi-agent control system for an environment. A method includes generating an observation of an environment by a first agent process and sending a first message that includes the observation to a meta-agent process. The method includes receiving a second message that includes a goal, by the first agent process and from the meta-agent process. The method includes evaluating a plurality of actions, by the first agent process and based on the goal, to determine a selected action. The method includes applying the selected action to the environment by the first agent process.

### CROSS-REFERENCE TO OTHER APPLICATION

This application claims the benefit of the filing date of U.S. Provisional Patent Application 62/646,404, filed Mar. 22, 2018, which is hereby incorporated by reference.

### TECHNICAL FIELD

The present disclosure is directed, in general, to systems and methods for automated collaborative planning.

### BACKGROUND OF THE DISCLOSURE

Processing of large amounts of diverse data is often impossible to be performed in any manual fashion. Automated processes can be difficult to implement, inaccurate, and inefficient. Improved systems are desirable.

### SUMMARY OF THE DISCLOSURE

Various disclosed embodiments include a method, and corresponding systems and computer-readable mediums, for implementing a hierarchical multi-agent control system for an environment. A method includes generating an observation of an environment by a first agent process and sending a first message that includes the observation to a meta-agent process. The method includes receiving a second message that includes a goal, by the first agent process and from the meta-agent process. The method includes evaluating a plurality of actions, by the first agent process and based on the goal, to determine a selected action. The method includes applying the selected action to the environment by the first agent process.

In some embodiments, the meta-agent process executes on a higher hierarchical level than the first agent process and is configured to communicate with and direct a plurality of agent processes including the first agent process. In some embodiments, the observation is a partial observation that is associated with only a portion of the environment. In some embodiments, the first agent process and/or the meta-agent process is a reinforcement-learning agent. In some embodiments, the meta-agent process defines the goal based on the observation and a global policy. In some embodiments, the evaluation is also based on one or more local policies. In some embodiments, the evaluation includes determining a predicted result and associated reward for each of the plurality of actions, and the selected action is the action with the greatest associated reward. In some embodiments, the evaluation is performed by using a controller process to formulate the plurality of actions and using a critic process to identify a reward value associated with each of the plurality of actions. In some embodiments, the environment is a physical hardware being monitored and controlled by at least the first agent process. In some embodiments, the environment is one of a computer system, an electrical, plumbing, or air system, a heating, ventilation, and air conditioning system, a manufacturing system, a mail processing system, or a product transportation, sorting, or processing system. In some embodiments, the first agent process is one of a plurality of agent processes each configured to communicate with and be assigned goals by the meta-agent process. In some embodiments, the first agent process is one of a plurality of agent processes each configured to communicate with the meta-agent process and each of the other agent processes. In various embodiments, an agent can interact and receive messages from other agents, and a meta agent can receive messages from various other agents and then determine sub-goals for these agents.

Other embodiments include one or more data processing systems each comprising at least a processor and accessible memory, configured to perform processes as disclosed herein. Other embodiments include a non-transitory computer-readable medium encoded with executable instructions that, when executed, cause one or more data processing systems to perform processes as disclosed herein.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates an example of a hierarchical multi-agent RL framework in accordance with disclosed embodiments;

FIG. 2 illustrates a flexible communication framework in accordance with disclosed embodiments;

FIG. 3 illustrates a process in accordance with disclosed embodiments; and

FIG. 4 illustrates a block diagram of a data processing system in accordance with disclosed embodiments.

### DETAILED DESCRIPTION

The Figures discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

Disclosed embodiments related to systems and methods for understanding and operating in an environment where large volumes of heterogeneous streaming data is received. This data can include, for example, video, other types of imagery, audio, tweets, blogs, etc. This data is collected by a team of autonomous software “agents” that collaborate to recognize and localize mission-relevant objects, entities, and actors in the environment, infer their functions, activities and intentions, and predict events.

To achieve this, each agent can process its localized streaming data in a timely manner; represent its localized perception into a compact model to share with other agents, and plan collaboratively with other agents to collect additional data to develop a comprehensive, global, and accurate understanding of the environment.

In a reinforcement learning (RL) process, a reinforcement learning agent interacts with its environment in discrete time steps. At each time t, the agent receives an observation, which may include the “reward.” The agent then chooses an action from the set of available actions, which is subsequently sent to the environment. The environment moves to a new state, and the reward associated with the state transition is determined. The goal of an RL agent is to collect as much reward as possible. The agent can (possibly randomly) choose any action as a function of the history. The agent stores the results and rewards, and the agent's performance can by compared to that of an agent that acts optimally. The stored history of states, actions, rewards, and other data can enable the agent to “learn” about the long term consequences of its actions, and can be used to formulate policy functions (or simply “policies”) on which to base future decisions.

Other approaches to analyzing this flood of data are inadequate as they record the data now and process it later. Other approaches treat perception and planning as two separate and independent modules leading to poor decisions and lack tractable computational methods for decentralized collaborative planning. Collaborative optimal decentralized planning is a hard computational problem and becomes even more complicated when agents do not have access to the data at the same time and must plan asynchronously.

Moreover, other methods for decentralized planning assume that all agents have the same information at the same time or make other restrictive and incorrect assumptions that do not hold in the real world. Tedious handcrafted task decompositions cannot scale up to complex situations, so a general and scalable framework for asynchronous decentralized planning is needed.

For convenient reference, notation as used herein includes the following, though this particular notation is not required for any particular embodiment or implementation:

u an action in a set of actions U,

a an agent,

o an observation,

t a time step,

m a message in a set of messages M,

s a state in a set of states S,

π a policy function,

g a goal or subgoal,

aₘ a meta agent, process, policy, etc., and

r a reward.

In general, each agent observes the state of its associated system or process at multiple times, selects an action based on the observation and a policy, and performs the action. In a multi-agent setting, each agent a observes a state sₜϵS at a time step t, which may be asynchronous.

The agent, a at time t, chooses an action uₜ^{a}ϵU using a policy function π^{a}:S→U. Note that if the policy is stochastic, the agent can sample the action. In the case of a complex and fast changing environment, the environment is only partially observable. In such cases, instead of the true state of the environment sₜ, the agent can only obtain an observation oₜ^{a} that contains partial information about sₜ. As such, it is impossible to perform an optimal collaborative planning in such an environment. Examples of complex and fast changing environments include, but are not limited to, a microgrid going through fast dynamical changes due to abnormal events, an HVAC of a large building with fast changing loads, robot control, elevator scheduling, telecommunications, or a manufacturing task scheduling process in a factory.

Disclosed embodiments can use RL-based processes for collaborative optimal decentralized planning that overcome disadvantages of other approaches and enable planning even in complex and fast-changing environments.

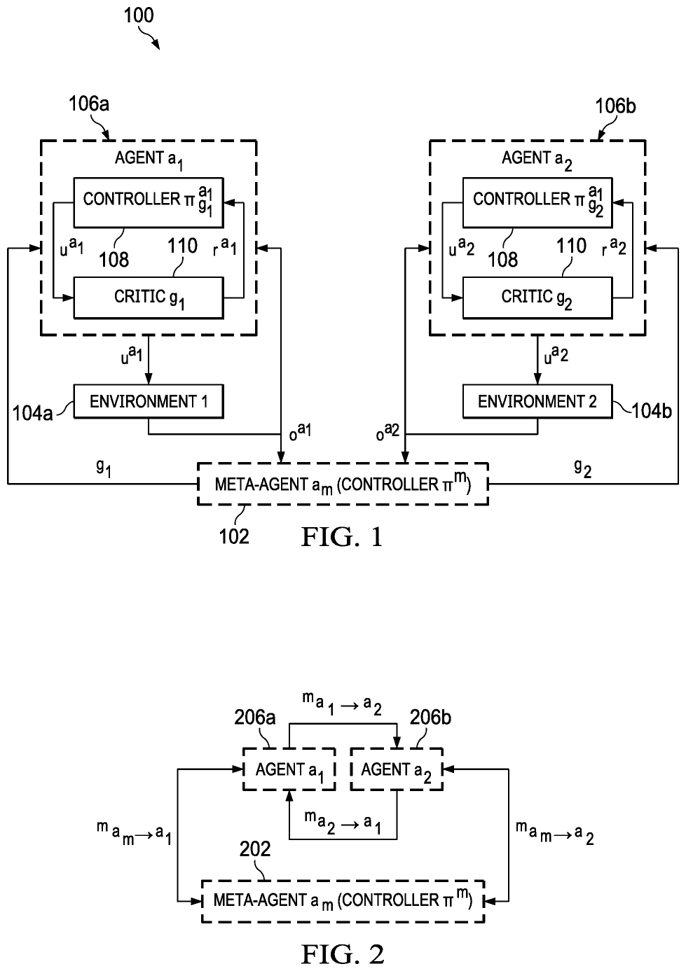

FIG. 1 illustrates an example of a hierarchical multi-agent RL framework 100 in accordance with disclosed embodiments, that can be implemented by one or more data processing systems as disclosed herein. Each of the processes, agents, controllers, critics, and other elements can be implemented on the same or different controllers, processors, or systems, and each environment can be physical hardware being monitored and controlled. The physical hardware being monitored and controlled can include other computer systems; electrical, plumbing, or air systems; HVAC systems, manufacturing systems; mail processing systems; product transportation, sorting, or processing systems, or otherwise. The agent processes, meta-agent processes, and other processes described below can be implemented, for example, as independently-functioning software modules that communicate and function as described, either synchronously or asynchronously, and can each use separate or common data stores, knowledge bases, neural networks, and other data, including replications or cached versions of any data.

As illustrated in FIG. 1, a meta-agent process 102 aₘ implements a controller process for policy π^{m}. Meta-agent process 102 is connected or configured to communicate with and receive observations o from one or more environments 104a/104b (or, singularly, an environment 104), and to communicate with one or more agents 106a/106b (or, singularly, an agent 106). Receiving observations can include receiving and analyzing any data corresponding to the environment 104, including any of the data forms or types discussed herein. A meta-agent process can be a reinforcement-learning agent.

Each agent 106 includes a controller process 108 and a critic process 110. Meta-agent process 102 is connected or configured to communicate goals g to each agent 106. Each controller process 108 formulates possible actions u that are delivered to its corresponding critic process 110, which returns a reward value r to the corresponding controller process 108. The possible actions u are based on the observations o of the environment and one or more policies π, which can be received from the meta-agent process 102. Each agent 106, after evaluating the possible actions u and corresponding rewards, can select a “best” action u and apply it to environment 104. Applying an action to an environment can include adjusting operating parameters, setpoints, configurations, or performing other modifications to adjust or control the operations of the corresponding physical hardware.

Disclosed embodiments can implement decentralized planning. In addition to partial observation oₜ^{a} (the observation o of an agent a at time t), each agent can observe mₜ^{a′}, a message from agent a′ (if a′ chooses to perform a “communication action” at time t.) The domain of the policy function π^{a} is then the product of the set of states s and the possible messages M. After training the system, the agents respond to the environment in a decentralized manner, communicating through such message channel. By modifying the nature of the communication channel, this framework can be used to emulate message broadcasting, peer-to-peer communication, as well as the stigmergic setting where the agents cannot communicate directly.

Disclosed embodiments can implement hierarchical planning. Meta-agent process 102 can be implemented as an RL agent configured to choose sub-goals for one or more lower-level RL agents 106. The low-level agent 106 then attempts to achieve a series of (not necessarily unique) subgoals g₁, g₂, g₃, . . . , g_{N} by learning separate policy functions π₁, π₂, π₃, . . . , π_{N}. Meta-agent process 102 attempts to maximize the top-level reward function r.

Disclosed embodiments can apply these techniques to a decentralized multi-agent setting and consider multiple levels of decision hierarchy. Further, communication actions are applied to the hierarchical setting by allowing the agents 106 to send messages to their meta-agents 102, and allowing the meta-agents 102 to send messages to the agents 106.

Disclosed embodiments can implement asynchronous action. In some RL settings, the agents observe the world and act at synchronized, discrete timesteps. Disclosed embodiments apply the RL framework to asynchronous settings. Each action u and observation o can take a varying amount of time t, and each agent's neural network updates its gradients asynchronously upon receiving a reward signal from the environment or the critic. Disclosed embodiments can apply Q-learning techniques, known to those of skill in the art, and update the Q-network each time the reward value is received.

Disclosed embodiments can implement task-optimal environment information acquisition. RL in partially observable environments is uses the agent to aggregate information about the environment over time. The aggregation can be performed by a recurrent neural network (RNN), which, during training, learns to compress and store information about the environment in a task-optimal way. Disclosed embodiments can also add information gathering as a possible action of each agent and can include information acquisition cost as a penalty that stops the agents from easily exploring the environment.

The processes described herein, such as illustrated with respect to FIG. 1, unifies these components in a principled manner. Disclosed embodiments support any number of agents and hierarchy levels, though FIG. 1 illustrates only two agents 106a/106b and two hierarchy levels for simplicity.

A meta-agent aₘ receives partial observations o^{a}^{₁}, o^{a}^{₂} from both agents' environments. aₘ is an RL agent whose set of actions includes setting goals g₁, g₂ for the subordinate agents and passing messages to the agents. This can be performed using messaging/communications as discussed below with respect to FIG. 2. Example subordinate goals, using a chess-game example, include “capture the bishop” or “promote a pawn”.

Each of the low-level agents is an RL agent optimizing a policy π_{g} to achieve the goal set by the meta-agent. Agent a₁ (and similarly a₂) receives partial observation o^{a}^{₁} of its environment, and chooses action u^{a}^{₁} that is judged by a goal-specific “critic” as successful (reward r^{a}^{₁}=1) if the goal is achieved, otherwise unsuccessful (r^{a}^{₁}=0).

In specific, preferred embodiment, agents can communicate hierarchically, through peer-to-peer protocols, and through stigmergy. This can implemented, for example, by varying the bandwidth of the peer-to-peer as well as peer-to-parent communication channels, as shown in FIG. 2.

In various embodiments, some or all of the agents are deep Q-net RL agents. Their decisions are based on discounted risks estimated, for each of the possible actions, by their Q-networks. Each Q-network's domain includes current environment observation and the space of possible actions of the agent. In addition, an agent can send a message to any of its peers or up/down the hierarchy. For example, aₘ can choose as its action to send a message mₐ_{ₘ}_{→a}_{₁} to a₁. That message can be is included as input to a₁'s Q-network. The content of the message can be a real number, a binary number with a fixed number of bits, or otherwise, which enables specific control of the communication channels.

For example, the system can restrict the peer-to-peer channels to 0 bits to enforce a strict hierarchical communication model in which the low-level agents can only communicate through the meta-agent. As another example, the system can restricting the agent-meta-agent channel to 0 bits to enforce peer-to-peer decentralized communication. As another example, the system can remove all inter-agent communication, as well as restricting the set of possible goals to only one (“win the game”), to enforce a restricted stigmergic model where the agents can only communicate through influencing each other's environments.

FIG. 2 illustrates a flexible communication framework in accordance with disclosed embodiments, illustrating the use of messages m between meta-agent 202 and agents 206a/206b. Messages can be passed between each of the agents and the meta agent—messages mₐ_{ₘ}_{→a}_{₁} between meta-agent 202 and agent 206a, messages mₐ_{ₘ}_{→a}_{₂} between meta-agent 202 and agent 206b, and messages mₐ_{₁}_{→a}_{₂} between agent 206a and agent 206b (and the reverse messages mₐ_{₂}_{→a}_{₁} between agent 206b and agent 206a).

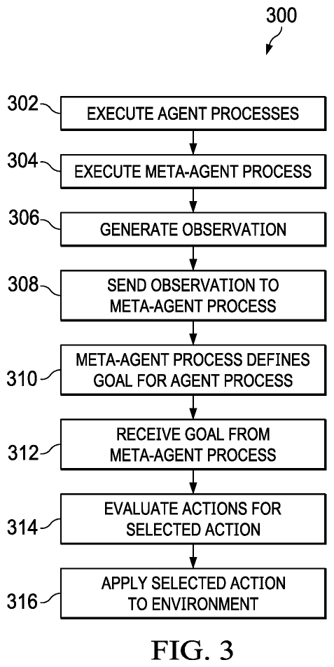

FIG. 3 illustrates a process 300 in accordance with disclosed embodiments that may be performed by one or more data processing systems as disclosed herein (referred to generically as the “system,” below), for implementing a hierarchical multi-agent control system for an environment. This process can be implemented using some, all, or any of the features, elements, or components disclosed herein. Where a step below is described as being performed by a specific element that may be implemented in software, it will be understood that the relevant hardware portion(s) of the system performs the step, such as a controller or processor of a specific data processing system performing the step.

The system executes one or more agent processes (302). Each agent process is configured to observe an environment and to perform actions on the environment. Each agent process can be implemented as a reinforcement-learning agent.

The system executes a meta-agent process (304). The meta-agent process executes on a higher hierarchical level than the one or more agent processes and is configured to communicate with and direct the one or more agent processes.

A first agent process of the one or more agent processes generates an observation of the environment (306). The observation of its environment by an agent can be a partial observation that is only associated with a portion of the environment. In some implementations, each agent process will generate partial observations of the environment so no agent process is responsible for observing the entire environment.

The first agent process sends a first message, to the meta-agent process, that includes the observation (308). Conversely, the meta-agent process receives the first message. The meta-agent process can be at a higher hierarchy than the first agent process.

The meta-agent process defines a goal for the first agent process based on the observation and a global policy (310). The global policy can be associated with a global goal and the goal for the first agent process can be a sub-goal of the global goal.

The meta-agent process sends a second message, to the first agent process, that includes the goal (312). Conversely, the first agent process receives the second message from the meta-agent process.

The first agent process evaluates a plurality of actions, based on the goal, to determine a selected action (314). The evaluation can be based on the goal and one or more local policies. The local policy or policies can be the same as or different from the global policy. The evaluation can include determining a predicted result and associated reward for each of the plurality of actions, and the selected action is the action with the greatest associated reward. The evaluation can be performed by the first agent process by using a controller process to formulate the plurality of actions and using a critic process to identify a reward value associated with each of the plurality of actions.

The first agent process applies the action to the environment (316).

The process can then repeat to 306 by generating an observation of the new state of the environment after the action is applied.

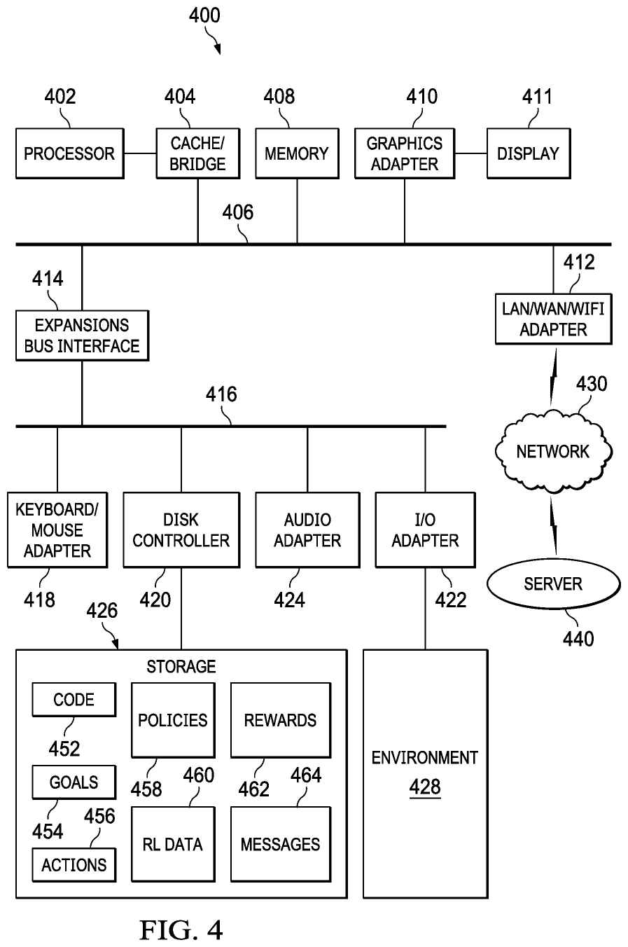

FIG. 4 illustrates a block diagram of a data processing system in which an embodiment can be implemented, for example as part of a system as described herein, or as part of a manufacturing system as described herein, particularly configured by software or otherwise to perform the processes as described herein, and in particular as each one of a plurality of interconnected and communicating systems as described herein. The data processing system depicted includes a processor 402 connected to a level two cache/bridge 404, which is connected in turn to a local system bus 406. Local system bus 406 may be, for example, a peripheral component interconnect (PCI) architecture bus. Also connected to local system bus in the depicted example are a main memory 408 and a graphics adapter 410. The graphics adapter 410 may be connected to display 411.

Other peripherals, such as local area network (LAN)/Wide Area Network/Wireless (e.g. WiFi) adapter 412, may also be connected to local system bus 406. Expansion bus interface 414 connects local system bus 406 to input/output (I/O) bus 416. I/O bus 416 is connected to keyboard/mouse adapter 418, disk controller 420, and I/O adapter 422. Disk controller 420 can be connected to a storage 426, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices. Storage 426 can store any data, software, instructions, or other information used in the processes described herein, including executable code 452 for executing any of the processes described herein, goals 454 including any global or local goals or subgoals, actions 456, policies 458 including any global or local policies, RL data 460 including databases, knowledgebases, neural networks, or other RL data, rewards 462, message 464, or other data.

Also connected to I/O bus 416 in the example shown is audio adapter 424, to which speakers (not shown) may be connected for playing sounds. Keyboard/mouse adapter 418 provides a connection for a pointing device (not shown), such as a mouse, trackball, trackpointer, touchscreen, etc. I/O adapter 422 can be connected to communicate with or control environment 428, which can include any physical systems, devices, or equipment as described herein or that can be controlled using actions as described herein.

Those of ordinary skill in the art will appreciate that the hardware depicted in FIG. 4 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 412 can be connected to a network 430 (not a part of data processing system 400), which can be any public or private data processing system network or combination of networks, as known to those of skill in the art, including the Internet. Data processing system 400 can communicate over network 430 with server system 440 (such as cloud systems or other server system), which is also not part of data processing system 400, but can be implemented, for example, as a separate data processing system 400, and can communicate over network 430 with other data processing systems 400, any combination of which can be used to implement the processes and features described herein.

Of course, those of skill in the art will recognize that, unless specifically indicated or required by the sequence of operations, certain steps in the processes described above may be omitted, performed concurrently or sequentially, or performed in a different order.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 400 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

Disclosed embodiments can incorporate a number of technical features which improve the functionality of the data processing system and help produce improved collaborative interactions. For example, disclosed embodiments can perform collaborative optimal planning in a fast-changing environment where a large amount of distributed information/data is present. Disclosed embodiments can use deep RL-based agents that can perceive and learn in such an environment and can perform planning in an asynchronous environment where all agents do not have the same information at the same time.

The following documents describe reinforcement learning and other issues related to techniques disclosed herein, and are incorporated by reference:
Cooper, G. (1990). The computational complexity of probabilistic inference using Bayesian belief networks. Artificial intelligence 42.2-3, 393-405.
Dagum, P., & Chavez, R. (1993). Approximating probabilistic inference in Bayesian belief networks. IEEE Transactions on Pattern Analysis and Machine Intelligence, 15.3, 246-255.
Hausknecht, M. a. (2015). Deep recurrent q-learning for partially observable MDPs. CoRR, abs/1507.06527.
Jaakkola, T. S. (1995). Reinforcement learning algorithm for partially observable Markov decision problems. Advances in neural information processing systems, (pp. 345-352).
Mnih, V. B. (2016). Asynchronous methods for deep reinforcement learning. International Conference on Machine Learning, (pp. 1928-1937).
Tejas Kulkarni, K. N. (2016). Hierarchical deep reinforcement learning: Integrating temporal abstraction and intrinsic motivation. Advances in neural information processing systems, (pp. 3675-3683).
Whiteson, J. F. (2016). Learning to communicate with deep multi-agent reinforcement learning. Advances in Neural Information Processing Systems, (pp. 2137-2145).

None of the description in the present application should be read as implying that any particular element, step, or function is an essential element which must be included in the claim scope: the scope of patented subject matter is defined only by the allowed claims. Moreover, none of these claims are intended to invoke 35 USC § 112(f) unless the exact words “means for” are followed by a participle. The use of terms such as (but not limited to) “mechanism,” “module,” “device,” “unit,” “component,” “element,” “member,” “apparatus,” “machine,” “system,” “processor,” or “controller,” within a claim is understood and intended to refer to structures known to those skilled in the relevant art, as further modified or enhanced by the features of the claims themselves, and is not intended to invoke 35 U.S.C. § 112(f).

What is claimed is:

1. A method executed by one or more data processing systems, comprising:
generating an observation of an environment by a first agent process;
sending a first message that includes the observation, by the first agent process and to a meta-agent process;
receiving a second message that includes a goal, by the first agent process and from the meta-agent process;
evaluating a plurality of actions, by the first agent process and based on the goal, to determine a selected action; and
applying the selected action to the environment by the first agent process.

2. The method of claim 1, wherein the meta-agent process executes on a higher hierarchical level than the first agent process and is configured to communicate with and direct a plurality of agent processes including the first agent process.

3. The method of claim 1, wherein the observation is a partial observation that is associated with only a portion of the environment.

4. The method of claim 1, wherein the first agent process is a reinforcement-learning agent.

5. The method of claim 1, wherein the meta-agent process is a reinforcement-learning agent.

6. The method of claim 1, wherein the meta-agent process defines the goal based on the observation and a global policy.

7. The method of claim 1, wherein the evaluation is also based on one or more local policies.

8. The method of claim 1, wherein the evaluation includes determining a predicted result and associated reward for each of the plurality of actions, and the selected action is the action with the greatest associated reward.

9. The method of claim 1, wherein the evaluation is performed by using a controller process to formulate the plurality of actions and using a critic process to identify a reward value associated with each of the plurality of actions.

10. The method of claim 1, wherein the environment is physical hardware being monitored and controlled by at least the first agent process.

11. The method of claim 1, wherein the environment is one of a computer system, an electrical, plumbing, or air system, a heating, ventilation, and air conditioning system, a manufacturing system, a mail processing system, or a product transportation, sorting, or processing system.

12. The method of claim 1, wherein the first agent process is one of a plurality of agent processes each configured to communicate with and be assigned goals by the meta-agent process.

13. The method of claim 1, wherein the first agent process is one of a plurality of agent processes each configured to communicate with the meta-agent process and each of the other agent processes.

14. A data processing system comprising at least a processor and accessible memory, configured to perform a method as in claim 1.

15. A non-transitory computer-readable medium encoded with executable instructions that, when executed, cause a data processing system to perform a method as in claim 1.
